(19) United States
(12) Patent Application Publication
(10) Pub. No.: US 2022/0058501 A1
(43) Pub. Date: Feb. 24, 2022

(54) AUTOMATIC PLANNER, OPERATION ASSISTANCE METHOD, AND COMPUTER READABLE MEDIUM

(71) Applicants: NEC CORPORATION, Tokyo (JP); National Institute of Advanced Industrial Science and Technology, Tokyo (JP)

(72) Inventors: Shumpei KUBOSAWA, Tokyo (JP); Takashi ONISHI, Tokyo (JP); Yoshimasa TSURUOKA, Tokyo (JP); Takashi WASHIO, Tokyo (JP)

(73) Assignees: NEC CORPORATION, Tokyo (JP); National Institute of Advanced Industrial Science and Technology, Tokyo (JP)

(21) Appl. No.: 17/274,922

(22) PCT Filed: Jun. 18, 2019
(86) PCT No.: PCT/JP2019/024164

§ 371 Date: Mar. 10, 2021

(30) Foreign Application Priority Data
Sep. 12, 2018 (JP) 2018-170825

(51) Int. Cl. G06N 5/04; G06N 5/02

(52) U.S. Cl. CPC G06N 5/043; G06N 5/022

(57) ABSTRACT

Target state inference unit infers a target state of a system and a partial target state thereof between a first state of the system and the target state thereof based on the first state, inference knowledge, and quantitative knowledge, the system being configured to be operated based on a manipulation procedure. Manipulation sequence inference unit infers a manipulation for a transition to the partial target state based on a manipulation derivation rule. Learning setting generation unit generates a learning setting for the inferred manipulation based on a learning setting derivation rule. A learning agent creates information about detailed manipulations in the manipulation based on the learning setting for the manipulation.

### TECHNICAL FIELD

The present disclosure relates to an operation assistance system, an operation assistance method, an automatic planner, and a computer readable medium.

### BACKGROUND ART

Patent Literature 1 discloses an adjustment rule generation apparatus that generates an adjustment rule for appropriately and easily adjusting inputs to a multi-input/output system having a nonlinear characteristic so that desired outputs can be obtained from the system. The adjustment rule generation apparatus described in Patent Literature 1 makes selections as to which adjustment element of an object to be adjusted (manipulated variable=input to object to be adjusted) should be used, and as to which adjustable parameter (controlled variable=output from object to be adjusted) should be adjusted. Further, the adjustment rule generation apparatus generates and outputs an adjustment rule for the combination of the selected manipulated variable and the controlled variable according to a predetermined format.

Specifically, the adjustment rule generation apparatus generates an adjustment rule by using dependency characteristic data and controlled variable correlation characteristic data. Note that the dependency characteristic data is data indicating whether or not there is a dependency relation between the manipulated variable of the object to be adjusted and the controlled variable thereof (i.e., between the input and the output). Further, the controlled variable correlation characteristic data is data that qualitatively represents how controlled variables change with respect to each other in response to each manipulated variable. Regarding the controlled variable correlation characteristic data, characteristics between arbitrary two controlled variables are classified into three groups, i.e., into “They change in the same direction as each other”, “They change in directions different from each other”, and “Only one of them changes”.

In the adjustment rule generation apparatus, it is possible, by using the above-described dependency characteristic data, to determine which controlled variable should be adjusted and by which manipulated variable that controlled variable should be adjusted. The adjustment rule generation apparatus estimates an adjustment characteristic by narrowing down the relation between the controlled variable of interest and the manipulated variable using dependency characteristic data and paying attention to the controlled variable correlation characteristic data for the narrowed relation. For example, when a manipulated variable X1 is manipulated, the adjustment rule generation apparatus estimates an adjustment characteristic indicating that controlled variables Y2 and Y3 change in the same direction. In such a case, when the controlled variables Y2 and Y3 have roughly the same deviation and both of them are outside a permissible deviation range, the adjustment rule generation apparatus can adjust their deviations by using the manipulated variable X1 that changes these controlled variables Y2 and Y3 in the same direction. The adjustment rule generation apparatus outputs an adjustment rule in which a rule for such an adjustment is described in a predetermined format.

### CITATION LIST

### Patent Literature

Patent Literature 1: Japanese Unexamined Patent Application Publication No. H10-268906

### SUMMARY OF INVENTION

### Technical Problem

In Patent Literature 1, when there is a deviation in a controlled variable, it is possible to determine which manipulated variable should be manipulated by referring to the adjustment rule. However, in Patent Literature 1, for example, when the dependency relation is complicated, it is impossible to determine the order according to which a plurality of manipulated variables are manipulated. In addition, in Patent Literature 1, it is possible only to determine which manipulated variable should be manipulated. That is, it is impossible to determine detailed manipulations in the manipulation.

In view of the above-described circumstances, an object of the present disclosure is to provide an operation assistance system, an operation assistance method, an automatic planner, and a computer readable medium capable of outputting information as to what kind of a manipulation(s) should be performed and how the manipulation(s) should be performed in a system.

### Solution to Problem

To achieve the above-described object, the present disclosure provides an operation assistance system including: target state inference means for inferring a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements; manipulation sequence inference means for inferring a manipulation for a transition to the partial target state based on a manipulation derivation rule; learning setting generation means for generating a learning setting for the inferred manipulation based on a learning setting derivation rule; and a learning agent configured to create information about detailed manipulations in the manipulation based on the learning setting for the manipulation.

Further, the present disclosure provides an automatic planner including: target state inference means for inferring a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements; manipulation sequence inference means for inferring a manipulation for a transition to the partial target state based on a manipulation derivation rule; learning setting generation means for generating a learning setting for the inferred manipulation based on a learning setting derivation rule, and outputting the generated learning setting to a learning agent configured to create information about detailed manipulations in the manipulation.

The present disclosure provides an operation assistance method including: inferring a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements; inferring a manipulation for a transition to the partial target state based on a manipulation derivation rule; generating a learning setting for the inferred manipulation based on a learning setting derivation rule, and outputting the generated learning setting to a learning agent configured to create information about detailed manipulations in the manipulation.

The present disclosure provides a computer readable medium storing a program for causing a computer to perform processing including: inferring a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements; inferring a manipulation for a transition to the partial target state based on a manipulation derivation rule; generating a learning setting for the inferred manipulation based on a learning setting derivation rule, and outputting the generated learning setting to a learning agent configured to create information about detailed manipulations in the manipulation.

### Advantageous Effects of Invention

An operation assistance system, an operation assistance method, an automatic planner, and a computer readable medium according to the present disclosure can output information as to what kind of a manipulation(s) should be performed and how the manipulation(s) should be performed in a system.

### BRIEF DESCRIPTION OF DRAWINGS

FIG. 1 is a block diagram schematically showing an operation assistance system according to the present disclosure;

FIG. 2 is a block diagram showing an operation assistance system according to an example embodiment of the present disclosure;

FIG. 3 is a flowchart showing an operation procedure performed in an operation assistance system;

FIG. 4 is a block diagram showing an example of a plant; and

FIG. 5 is a block diagram showing an example of a configuration of an information processing apparatus.

### DESCRIPTION OF EMBODIMENTS

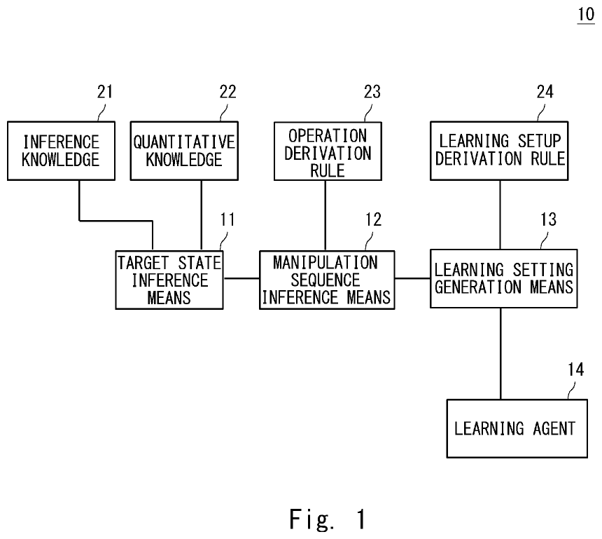

Prior to describing example embodiments according to the present disclosure, an overview of the disclosure will be described. FIG. 1 schematically shows an operation assistance system according to the present disclosure. The operation assistance system 10 includes target state inference means 11, manipulation sequence inference means 12, learning setting generation means 13, and a learning agent 14.

The target state inference means 11 infers a target state based on a first state of a system which is operated based on a manipulation procedure including the order of manipulation elements and a manipulated variable of each of the manipulation elements, inference knowledge 21 of the system, and quantitative knowledge 22 of the system. The inference knowledge 21 includes a relation between states of the system. The quantitative knowledge 22 includes numerical knowledge in the system. Further, the target state inference means 11 infers a partial target state(s) between the first state and the target state based on the inference knowledge 21.

The manipulation sequence inference means 12 infers a manipulation for a transition to the partial target state based on a manipulation derivation rule 23. The manipulation derivation rule 23 includes, for example, information associating a state of the system before the transition, the manipulation to be performed, and a state to which the system will change after the manipulation is performed. The learning setting generation means 13 generates a learning setting for the inferred manipulation based on a learning setting derivation rule 24. The learning setting derivation rule 24 includes, for example, information associating a manipulation with a learning setting that is applied when that manipulation is performed. The learning agent 14 creates information about detailed manipulations in the manipulation based on the learning setting for the manipulation generated by the learning setting generation means 13.

In the present disclosure, a target state after the manipulation and a partial target state(s) before reaching the target state are inferred by using the inference knowledge 21 and the quantitative knowledge 22. Further, a manipulation for a transition to each partial state is inferred by using the manipulation derivation rule 23, and a learning setting for the manipulation is generated by using the learning setting derivation rule 24. In the present disclosure, it is possible, in the learning agent 14, to output information as to what kind of a manipulation(s) should be performed and how the manipulation(s) should be performed to reach the target state (or the partial target state) to a user or the like by creating information about detailed manipulations in the manipulation based on the learning setting. Further, the user can control the system such as a plant into a desired state by operating the system according to the output information.

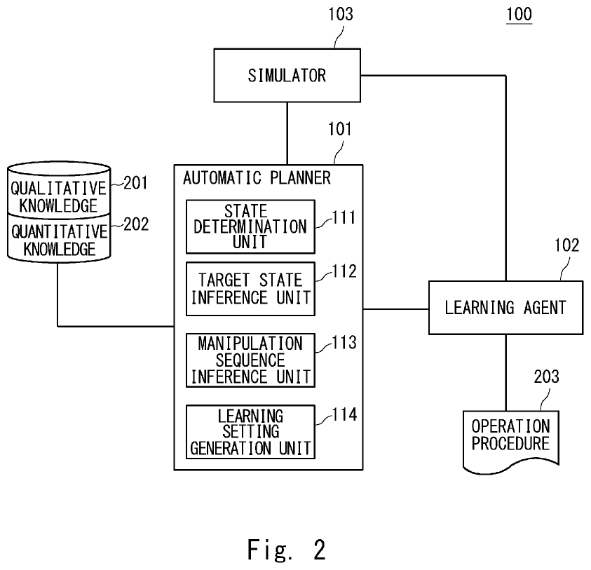

Example embodiments according to the present disclosure will be described hereinafter in detail with reference to the drawings. FIG. 2 shows an operation assistance system according to an example embodiment of the present disclosure. The operation assistance system 100 includes an automatic planner 101, a learning agent 102, and a simulator 103. The automatic planner 101, the learning agent 102, and the simulator 103 are formed by using, for example, a computer apparatus including a processor and a memory. Functions of these elements may be implemented as the processor operates according to a program read from the memory.

In this example embodiment, the automatic planner 101, the learning agent 102, and the simulator 103 do not necessarily have to be formed as physically separated apparatuses. For example, the automatic planner 101 and at least one of the learning agent 102 and the simulator 103 may be formed as the same apparatus. Further, the automatic planner 101, the learning agent 102, and the simulator 103 do not necessarily have to be located in the same place. For example, the automatic planner 101 may be connected to at least one of the learning agent 102 and the simulator 103 through a network, and may transmit/receive information to/from them through the network.

The automatic planner 101 includes a state determination unit 111, a target state inference unit 112, a manipulation sequence inference unit 113, and a learning setting generation unit 114. The state determination unit (the state determination means) 111 determines whether or not the state of the system such as a plant operated based on a manipulation procedure including the order of manipulation elements and a manipulated variable of each of the manipulation elements is a state that requires a manipulation(s) (i.e., is a first state). The simulator 103 simulates the system operated based on the manipulation procedure. The state determination unit 111 monitors the state of the system simulated by the simulator 103 and determines whether or not a manipulation(s) is necessary.

Qualitative knowledge 201 is qualitative knowledge in the system such as a plant. The qualitative knowledge 201 includes knowledge of, for example, an operation rule in a plant, a dependency relation between manipulation procedures, and as to what kind of a manipulation(s) should be performed to change the state of the system from one state to another state. The qualitative knowledge 201 includes the inference knowledge 21, the manipulation derivation rule 23, and the learning setting derivation rule 24 shown in FIG. 1.

Quantitative knowledge 202 is knowledge about numerical values in the system such as a plant. The quantitative knowledge 202 includes knowledge about a threshold used for a determination, an indicated value of a sensor or the like in a steady state, an amount of a raw material, and the like. The quantitative knowledge 202 corresponds to the quantitative knowledge 22 shown in FIG. 1. The qualitative knowledge 201 and the quantitative knowledge 202 are stored in an apparatus, such as an auxiliary storage device, accessible from the automatic planner 101.

When the state determination unit 111 determines that a manipulation(s) is necessary, the target state inference unit (the target state inference unit) 112 infers a target state based on the qualitative knowledge 201, the quantitative knowledge 202, and the current state of the system. Further, the target state inference unit 112 infers a partial target state(s) between the current state and the inferred target state based on the qualitative knowledge 201.

More specifically, the qualitative knowledge 201 includes first inference knowledge defining a state before the manipulation and a target state after the manipulation while associating them with each other, and second inference knowledge defining a state transition between the states. The target state inference unit 112 infers the target state by using the first inference knowledge. Further, the target state inference unit 112 infers a partial target state at each stage from the current state to the target state by using the second inference knowledge. The target state inference unit 112 infers a partial target state at each stage, for example, by tracing back from the inferred target state to the current state by using the second inference knowledge. The target state inference unit 112 corresponds to the target state inference means 11 shown in FIG. 1.

The manipulation sequence inference unit (the manipulation sequence inference means) 113 infers a manipulation(s) for a transition to each partial target state based on the manipulation derivation rule included in the qualitative knowledge 201. The manipulation derivation rule includes, for example, information associating the state of the system before the transition, the manipulation to be performed, and the state to which the system will change after the manipulation is performed. The manipulation sequence inference unit 113 infers a sequence of manipulations for changing the state of the system from the current state or the immediately previous partial target state to the next partial target state or the final target state based on the manipulation derivation rule. The manipulation sequence inference unit 113 corresponds to the manipulation sequence inference means 12 shown in FIG. 1.

The learning setting generation unit (the learning setting generation means) 114 generates a learning setting for each manipulation inferred by the manipulation sequence inference unit 113 based on the learning setting derivation rule included in the qualitative knowledge 201. The learning setting derivation rule includes, for example, information associating a manipulation with a learning setting that is applied when that manipulation is performed. The learning setting includes, for example, an input variable to the learning agent 102, an output variable of the learning agent 102, an objective function, and a type of learning. The learning setting generation unit 114 corresponds to the learning setting generation means 13 shown in FIG. 1.

The learning agent 102 learns (creates) information about detailed manipulations in each manipulation based on the learning setting generated by the learning setting generation unit 114 of the automatic planner 101. Note that the learning agent 102 acquires a quantitative response of the system from the simulator 103, and performs learning based on the acquired quantitative response. Additional information, such as an operational constraint in the system, may be set in the learning agent 102. The learning agent 102 corresponds to the learning agent 14 shown in FIG. 1.

For example, the learning agent 102 learns, when a state that is determined to require a manipulation is defined as an initial state, how much a valve should be opened when a sensor indicates how much value. The learning agent 102 generates a manipulation procedure 203 including information about detailed manipulations in each learned manipulation. The learning agent 102 outputs the generated manipulation procedure 203 for the user. Upon a detection of a state that requires a manipulation by the state determination unit 111, the manipulation procedure 203 is generated, so that the user can recognize what kind of manipulation(s) should be performed and how the manipulation(s) should be performed in that state.

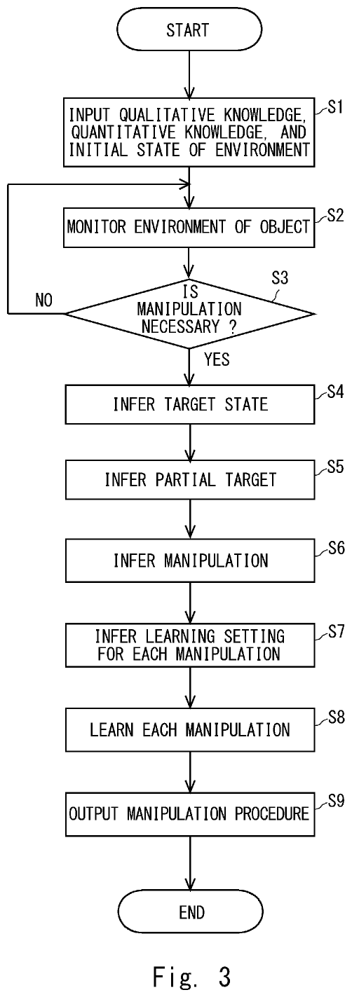

Next, a manipulation procedure will be described. FIG. 3 shows an operation procedure (an operation assistance method) performed in the operation assistance system 10. A user enters qualitative knowledge 201, quantitative knowledge 202, and an initial state of the environment of the simulator 103 by using an input device such as a keyboard and a mouse (not shown) (step S1). The simulator 103 starts to operate from the initial state input in the step S1.

The state determination unit 111 of the automatic planner 101 acquires the current state (simulation values) from the simulator 103 and monitors the environment of the object to be manipulated (step S2). The state determination unit 111 determines whether or not the current state is a state that requires a manipulation (step S3). For example, when a value of a certain sensor indicates an abnormal value, the state determination unit 111 determines that the current state is a state requiring a manipulation. For example, when the value of the sensor indicates a normal value, the state determination unit 111 determines that the current state is a state requiring no manipulation.

When the state determination unit 111 determines that the current state is a state requiring no manipulation in the step S3, it returns to the step S2 and continues the monitoring of the environment of the object to be manipulated. When the state determination unit 111 determines that the current state is a state requiring a manipulation in the step S3, it notifies the target state inference unit 112 of the current state, which is the manipulation-requiring state. The target state inference unit 112 infers a target state after the manipulation based on the current state, the qualitative knowledge 201, and the quantitative knowledge 202 (step S4). The qualitative knowledge 201 includes information associating the manipulation-requiring state and the target state after the manipulation as first inference knowledge, and the target state inference unit 112 infers the final target state by using such first inference knowledge in the step S4.

The target state inference unit 112 infers a partial target state(s) between the current state and the final target state based on the current state, the target state after the manipulation, and the qualitative knowledge 201 (step S5). The qualitative knowledge 201 includes, as second inference knowledge, information in which a state transition from one state to another state (a causal relation between states) is described, and the target state inference unit 112 infers a partial target state(s) by using such second inference knowledge in the step S5. Note that there may be a case where no partial target state exists, such as a case where the current state can be directly changed to the target state after a manipulation(s).

The manipulation sequence inference unit 113 infers a sequence of manipulations necessary to change the state of the system from the current state to the target state after the manipulation based on the current state, each partial target state, the target state, and the manipulation derivation rule included in the qualitative knowledge 201 (step S6). In the step S6, the manipulation sequence inference unit 113 hypothetically infers, for example, a sequence of manipulations necessary for a transition to the next state by using the manipulation derivation rule.

The learning setting generation unit 114 infers a learning setting for each manipulation included in the manipulation sequence, which is inferred by the manipulation sequence inference unit 113, by using the learning setting derivation rule included in the qualitative knowledge 201 (step S7). In the step S7, the learning setting generation unit 114 hypothetically infers, for example, the learning setting for each manipulation by using the learning setting derivation rule.

The learning setting generation unit 114 passes the generated learning settings to the learning agent 102. The learning agent 102 performs learning based on the learning setting generated in the step S7, and learns, for example, information about detailed manipulations in each manipulation (step S8). For example, the learning agent 102 includes a learning unit corresponding to each manipulation and learns information about detailed manipulations by using a corresponding learning unit.

The learning agent 102 outputs information about each manipulation and detailed manipulations in that manipulation as the manipulation procedure 203 (step S9). Instead of having the learning agent 102 output the manipulation procedure 203, the automatic planner 101 may acquire information about detailed manipulations in each manipulation from the learning agent 102 and output the manipulation procedure 203. The manipulation procedure 203 is displayed, for example, in a display apparatus (not shown). The user can recognize which element or the like should be manipulated and how the element or the like should be manipulated by referring to the manipulation procedure 203.

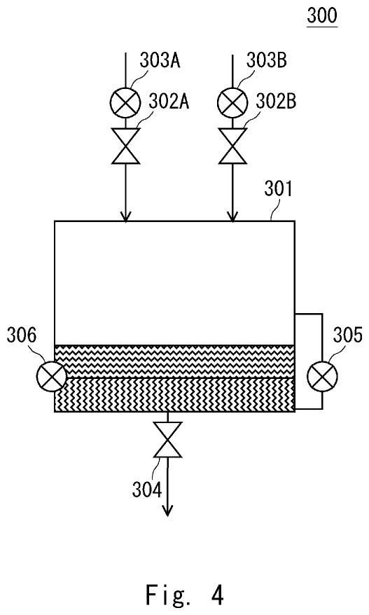

Descriptions will be given hereinafter by using specific examples. FIG. 4 shows an example of a plant. In this example, assume, as a plant, a plant 300 including a tank 301 into which liquids A and B are put (e.g., pumped). The liquid A is put into the tank 301 through an injection valve 302A and the liquid B is put through an injection valve 302B. A flowmeter 303A measures the amount of the put liquid A. A flowmeter 303B measures the amount of the put liquid B. A water gauge (a level gauge) 305 measures the liquid level of the liquid put into the tank 301. A thermometer 306 measures the temperature of the outside air around the tank 301. The liquids A and B put into the tank 301 are discharged from the tank 301 through a discharge valve 304. In the plant 300, the components to be manipulated are the injection valves 302A and 302B, and the discharge valve 304. The simulator 103 (see FIG. 2) simulates the behavior of the above-described plant 300.

In this example, assume the following conditions as preconditions. It is assumed that the liquid B is lighter than the liquid A, so that the liquid B floats on the liquid A in the tank. Further, it is also assumed that the liquids A and B cannot be simultaneously put (e.g., simultaneously pumped) into the tank. Regarding the order of putting the liquids, it is assumed that the liquid A is put into the tank before the liquid B is. It is assumed that the liquid A generates a large amount of heat when it is put into the tank all at once. Similarly, it is assumed that the liquid B generates a large amount of heat when it is put into the tank all at once. It is assumed that the amounts of supplied liquids A and B change. It is assumed that the temperature of the tank needs to be kept below 60 degrees. Further, it is assumed that the temperature of the tank is cooled by the outside air.

In the above-described plant 300, it is assumed that: in the current state, the tank 301 is empty; the discharge valve 304 is “opened”; the injection valves 302A and 302B are “closed”; and the temperature of the outside air measured by the thermometer 306 is “hot”. It is assumed that when the water level detected by the water gauge 305 is zero, i.e., when the tank 301 is empty, the state determination unit 111 determines that it is in a state that requires a manipulation(s).

The qualitative knowledge 201 holds inference knowledge (first inference knowledge) that the target state after the manipulation for the state in which the tank 301 is empty is a state in which the liquids A and B have been put (e.g., pumped) into the tank 301. Further, the quantitative knowledge 202 holds information that the amount of the put liquid A is “20 kg” and the amount of the put liquid B is “30 kg” for a state in which the outside air is “hot”. In this case, the target state inference unit 112 infers that: the target state after the manipulation is a state in which the liquids A and B have been put; the amount of the put liquid A is 20 kg; and the amount of the put liquid B is 30 kg.

The qualitative knowledge 201 holds, as information about transitions among states (second inference knowledge), “Empty (Tank)->Discharge Stop (Tank)”, “Discharge Stop (Tank)->State in which Liquid A is being put (Tank)”, and “State in which only Liquid A is being put (Tank)->State in which only Liquid A has been put (Tank)”. The symbol “->” indicates that the state (postconditions) described after the symbol “->” can be derived from the state (conditions, preconditions) described before the symbol “->”. The symbol “->” does not necessarily represent a logical derivation, and may represent, for example, a temporal transition or the like. Further, the qualitative knowledge 201 also holds “State in which only Liquid A has been put (Tank)->State in which Liquid B is being put (Tank)” and “State in which Liquid B is being put (Tank)->State in which Liquids A and B have been put (Tank)”. The target state inference unit 112 infers, for example, a partial target(s) before reaching the final target by tracing back from the target state “State in which Liquids A and B have been put” to the current state “Empty (Tank)” by using the second inference knowledge. The target state inference unit 112 may start the inference from the current state to the target state from the current state. The target state inference unit 112 infers, as partial target states, “Discharge Stop (Tank)”, “State in which Liquid A is being put”, “State in which only Liquid A has been put”, “State in which Liquid B is being put”, and “State in which Liquids A and B have been put”.

The qualitative knowledge 201 holds, as a manipulation derivation rule, knowledge (information) that “Empty (Tank)\hat{ }Closed (Discharge valve)->Discharge Stop (Tank)”. The symbol “\hat{ }” indicates a logical multiplication. The manipulation sequence inference unit 113 makes a hypothetical inference from the fact “Empty (Tank) and Discharge Stop (Tank)” and the manipulation derivation rule, and infers that the manipulation for the transition to the “Discharge Stop (Tank)” is a manipulation for changing the discharge valve 304 from “opened” to “closed” based on the difference from the current state.

Further, the qualitative knowledge 201 holds, as a manipulation derivation rule, knowledge that “Discharge Stop (Tank)\hat{ }Closed (Discharge Valve)\hat{ }Opened (Liquid A Injection Valve)\hat{ }Closed (Liquid B Injection Valve)->State in which Liquid A is being put (Tank)”. The manipulation sequence inference unit 113 makes a hypothetical inference from the fact “Discharge Stop (Tank) and State in which Liquid A is being put (Tank)” and the manipulation derivation rule. The manipulation sequence inference unit 113 infers that the manipulation for the transition to “State in which Liquid A is being put (Tank)” is a manipulation for changing the injection valve 302A from “Closed” to “Opened” based on the difference from the state before the manipulation.

Similarly, for the subsequent partial target states, the manipulation sequence inference unit 113 makes a hypothetical inference by using the manipulation derivation rule held in the qualitative knowledge 201. The manipulation sequence inference unit 113 infers a manipulation for a transition to the next partial target state or the final target state from the difference from the state before the manipulation. The manipulation sequence inference unit 113 infers, as a sequence of manipulations for the transition to the target state, “Close Discharging Valve”, “Open Liquid A Injection Valve”, “Close Liquid A Injection Valve”, “Open Liquid B Injection Valve”, and “Close Liquid B Injection Valve”.

The qualitative knowledge 201 holds, as a learning setting derivation rule, knowledge that no learning is necessary for “Closed (Discharge Valve)”. In this case, the learning setting generation unit 114 outputs, to the learning agent 102, information indicating that no learning is necessary for the manipulation for “Closed (Discharge Valve)”.

Further, the qualitative knowledge 201 holds, as a learning setting derivation rule, knowledge (information) that the learning setting for “Opened (Liquid A Injection Valve)\hat{ }20 kg (Liquid A injection amount)” is “Learning Unit (Reinforcement Learning)^{A} Environment (Liquid A Flowmeter, Thermometer, Water Gauge, and Amount of Put Liquid A)\hat{ }Behavior (Degree of Opening of Liquid A Injection Valve)\hat{ }Reward (Reward Functions A20)\hat{ }Terminating Condition (Put 20 kg of Liquid A)”. Note that the reward function A20 is a continuous function separately defined as “A score high enough to quickly put 20 kg of the liquid A at a temperature lower than 60 degrees”. In this case, the learning setting generation unit 114 generates a learning setting by performing hypothetical inference from the fact “Opened (Liquid A Injection Valve)\hat{ }20 kg (Amount of Put Liquid)” and the learning setting derivation rule, and outputs the generated learning setting to the learning agent 102. The learning setting generation unit 114 outputs, as a learning setting for the manipulation for “Opened (Liquid A Injection Valve)”, “Learning Unit=Reinforcement Learning, Environment={Liquid A flowmeter, Thermometer, Water Gauge, Amount of Put Liquid A}, Behavior=Degree of Opening of Liquid A Injection Valve, Reward=r (Reward Function A20), Terminating Condition=Put 20 kg of Liquid A” to the learning agent 102. The same applies to the liquid B.

The learning agent 102 performs machine learning according to the learning setting for each manipulation. For example, the learning agent 102 learns, for the manipulation of “Opened (Liquid A Injection Valve)”, time series data of the degree of opening of the injection valve 302A at which 20 kg of the liquid A can be quickly put at a temperature lower than 60 degrees. The learning agent 102 outputs, as a manipulation procedure 203, a sequence of manipulations from the current state to the final target state, and information about detailed manipulations in each manipulation.

In this example embodiment, when the state of the system such as a plant is a state that requires a manipulation(s), the target state inference unit 112 infers the target state after manipulation by using the qualitative knowledge 201 and the quantitative knowledge 202. The manipulation sequence inference unit 113 infers a sequence of manipulations for changing the state of the system from the state that requires the manipulation to the inferred target state by using the qualitative knowledge 201. Further, the learning setting generation unit 114 generates a learning setting for each manipulation. Further, the learning agent 102 learns information about detailed manipulations in each manipulation according to the learning setting, and generates a manipulation procedure 203 including information about manipulations and detailed manipulations in the manipulations. In this example embodiment, the manipulation procedure 203 includes not only the information about manipulations but also the information about detailed manipulations in these manipulations, and a user can recognize which manipulation(s) should be performed and how the manipulation(s) should be performed by referring to the manipulation procedure 203. The user can control the system such as a plant into a desired state by operating the system according to the output manipulation procedure 203.

Note that, in the above-described example embodiment, an example in which reinforcement learning is mainly performed by the learning agent 102 is described. However, the learning is not limited to the reinforcement learning. The learning may be supervised learning or may be unsupervised learning. For example, in the case where there is a model for predicting a predicted value of a certain sensor by using values indicated by several other sensors, a model may be constructed by performing supervised learning in the learning agent 102.

In the above-described case, when the difference between the predicted value of a pressure sensor A predicted by using the model and the indicated value of the pressure sensor A is larger than a threshold value, the state determination unit 111 determines that it is in a model deviation state and determines that the system is in a state that requires a manipulation(s). The target state inference unit 112 infers that the target state is to solve the model deviation state. In the case of “Model Deviation State\hat{ }Target is to Solve Model Deviation State”, the manipulation sequence inference unit 113 infers “Reconstruction of Model”. The learning setting generation unit 114 outputs, as a learning setting, “Input={Indicated Value of Pressure Sensor B, Indicated Value of Flow Sensor C}, Output=Indicated Value of Pressure Sensor A, Target Function=Minimize Square Error, Learning Unit=Logistic Regression, Environment=50-minute Simulation for Every 1-minute Observation”. In this case, it is possible to learn the predicted value of the sensor through supervised learning.

In the above-described example embodiment, an example in which the learning agent 102 acquires a quantitative response of the system such as a plant from the simulator 103 and performs learning thereof is described. However, the present disclosure is not limited this example. The learning agent 102 may acquire a quantitative response at the time when a manipulation is performed from the actual system and perform learning thereof.

The learning agent 102 may include a higher-level learning agent and a lower-level learning agent. In such a case, information about detailed manipulations in each manipulation may be learned by the lower-level learning agent, and the order of manipulations may be learned by the higher-level learning agent.

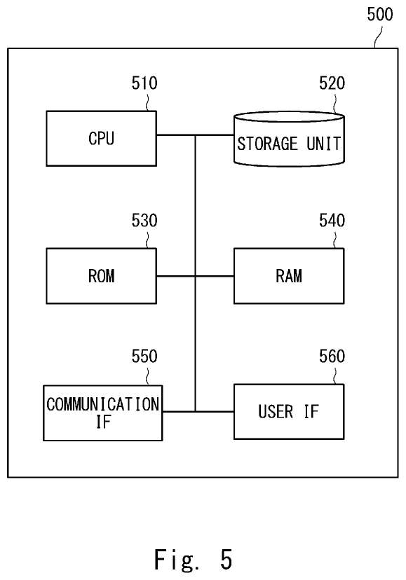

FIG. 5 shows an example of a configuration of an information processing apparatus (a computer apparatus) which can be used for the automatic planner 101, the learning agent 102, and the simulator 103. The information processing apparatus 500 includes a control unit (CPU: Central Processing Unit) 510, a storage unit 520, a ROM (Read Only Memory) 530, a RAM (Random Access Memory) 540, a communication interface (IF: Interface) 550, and a user interface 560.

The communication interface 550 is an interface for connecting the information processing apparatus 500 to a communication network through wired communication means, wireless communication means, or the like. The user interface 560 includes, for example, a display unit such as a display device. Further, the user interface 560 also includes an input unit such as a keyboard, a mouse, and a touch panel.

The storage unit 520 is an auxiliary storage device capable of holding various types of data. The storage unit 520 does not necessarily have to be a part of the information processing apparatus 500, and may be an external storage device or a cloud storage connected to the information processing apparatus 500 through a network. The ROM 530 is a nonvolatile storage device. For the ROM 530, for example, a semiconductor storage device such as a flash memory having a relatively small capacity is used. A program(s) executed by the CPU 510 can be stored in the storage unit 520 or the ROM 530.

The aforementioned program can be stored and provided to the information processing apparatus 500 by using any type of non-transitory computer readable media. Non-transitory computer readable media include any type of tangible storage media. Examples of non-transitory computer readable media include magnetic storage media such as floppy disks, magnetic tapes, and hard disk drives, optical magnetic storage media such as magneto-optical disks, optical disk media such as CD (Compact Disc) and DVD (Digital Versatile Disk), and semiconductor memories such as mask ROM, PROM (Programmable ROM), EPROM (Erasable PROM), flash ROM, and RAM. Further, the program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a radio communication line.

The RAM 540 is a volatile storage device. For the RAM 540, various semiconductor memory devices such as DRAM (Dynamic Random Access Memory) or SRAM (Static Random Access Memory) may be used. The RAM 540 may be used as an internal buffer for temporarily storing data or the like. The CPU 510 loads a program stored in the storage unit 520 or the ROM 530 into the RAM 540 and executes the loaded program. As the CPU 510 executes the program, functions of each unit in the automatic planner 101, the learning agent 102, and the simulator 103 are implemented. The CPU 510 may have an internal buffer capable of temporarily storing data or the like.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

For example, the whole or a part of the embodiments disclosed above can be described as, but not limited to, the following supplementary notes.

### [Supplementary Note 1]

An operation assistance system comprising:

target state inference means for inferring a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements;

manipulation sequence inference means for inferring a manipulation for a transition to the partial target state based on a manipulation derivation rule;

learning setting generation means for generating a learning setting for the inferred manipulation based on a learning setting derivation rule; and

a learning agent configured to create information about detailed manipulations in the manipulation based on the learning setting for the manipulation.

### [Supplementary Note 2]

The operation assistance system described in Supplementary note 1, wherein

the inference knowledge includes first inference knowledge defining a state before the manipulation and a target state after the manipulation while associating them with each other, and second inference knowledge defining a state transition between the states, and

the target state inference means infers the target state by using the first inference knowledge and infers the partial target state by using the second inference knowledge.

### [Supplementary Note 3]

The operation assistance system described in Supplementary note 2, wherein the target state inference means infers the partial target state by tracing back from the target state to the first state using the second inference knowledge.

### [Supplementary Note 4]

The operation assistance system described in any one of Supplementary notes 1 to 3, wherein the learning setting includes an input variable to the learning agent, an output variable of the learning agent, an objective function, and a type of learning.

### [Supplementary Note 5]

The operation assistance system described in any one of Supplementary notes 1 to 4, wherein the learning agent creates the information about detailed manipulations based on a quantitative response of the system.

### [Supplementary Note 6]

The operation assistance system described in Supplementary note 5, further comprising a simulator configured to simulate an operation of the system, wherein

the learning agent acquires the quantitative response of the system from the simulator.

### [Supplementary Note 7]

The operation assistance system described in Supplementary note 5, wherein the learning agent acquires the quantitative response of the system from the system.

### [Supplementary Note 8]

The operation assistance system described in any one of Supplementary notes 1 to 7, wherein the manipulation derivation rule includes information associating the state of the system before the transition, the manipulation to be performed, and the state to which the system will change after the manipulation is performed.

### [Supplementary Note 9]

The operation assistance system described in any one of Supplementary notes 1 to 8, wherein the learning setting derivation rule includes information associating a manipulation with the learning setting that is applied when the manipulation is performed.

### [Supplementary Note 10]

The operation assistance system described in any one of Supplementary notes 1 to 9, further comprising state determination means for determining whether or not the state of the system is a state that requires the manipulation.

### [Supplementary Note 11]

The operation assistance system described in any one of Supplementary notes 1 to 10, wherein the learning agent outputs the created information about detailed manipulations to a user.

### [Supplementary Note 12]

An automatic planner comprising:

target state inference means for inferring a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements;

manipulation sequence inference means for inferring a manipulation for a transition to the partial target state based on a manipulation derivation rule;

learning setting generation means for generating a learning setting for the inferred manipulation based on a learning setting derivation rule, and outputting the generated learning setting to a learning agent configured to create information about detailed manipulations in the manipulation.

### [Supplementary Note 13]

The automatic planner described in Supplementary note 12, wherein

the inference knowledge includes first inference knowledge defining a state before the manipulation and a target state after the manipulation while associating them with each other, and second inference knowledge defining a state transition between the states, and

the target state inference means infers the target state by using the first inference knowledge and infers the partial target state by using the second inference knowledge.

### [Supplementary Note 14]

The automatic planner described in Supplementary note 13, wherein the target state inference means infers the partial target state by tracing back from the target state to the first state using the second inference knowledge.

### [Supplementary Note 15]

The automatic planner described in any one of Supplementary notes 12 to 14, wherein the learning setting includes an input variable to the learning agent, an output variable of the learning agent, an objective function, and a type of learning.

### [Supplementary Note 16]

The automatic planner described in any one of Supplementary notes 12 to 15, further comprising state determination means for determining whether or not the state of the system is a state that requires the manipulation.

### [Supplementary Note 17]

An operation assistance method comprising:

inferring a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements;

inferring a manipulation for a transition to the partial target state based on a manipulation derivation rule;

generating a learning setting for the inferred manipulation based on a learning setting derivation rule, and outputting the generated learning setting to a learning agent configured to create information about detailed manipulations in the manipulation.

### [Supplementary Note 18]

A program for causing a computer to perform processing including:

inferring a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements;

inferring a manipulation for a transition to the partial target state based on a manipulation derivation rule;

generating a learning setting for the inferred manipulation based on a learning setting derivation rule, and outputting the generated learning setting to a learning agent configured to create information about detailed manipulations in the manipulation.

This application is based upon and claims the benefit of priority from Japanese patent application No. 2018-170825, filed on Sep. 12, 2018, the disclosure of which is incorporated herein in its entirety by reference.

### REFERENCE SIGNS LIST

10 OPERATION ASSISTANCE SYSTEM
11 TARGET STATE INFERENCE MEANS
12 MANIPULATION SEQUENCE INFERENCE MEANS
13 LEARNING SETTING GENERATION MEANS
14 LEARNING AGENT
21 INFERENCE KNOWLEDGE
22 QUANTITATIVE KNOWLEDGE
23 OPERATION DERIVATION RULE
24 LEARNING SETUP DERIVATION RULE
100 OPERATION ASSISTANCE SYSTEM
101 AUTOMATIC PLANNER
102 LEARNING AGENT
103 SIMULATOR
111 STATE DETERMINATION UNIT
112 TARGET STATE INFERENCE UNIT
113 MANIPULATION SEQUENCE INFERENCE UNIT
114 LEARNING SETTING GENERATION UNIT
201 QUALITATIVE KNOWLEDGE
202 QUANTITATIVE KNOWLEDGE
203 OPERATION PROCEDURE
301 TANK
302A, 302B INJECTION VALVE
303A, 303B FLOWMETER
304 DISCHARGE VALVE
305 WATER GAUGE
306 THERMOMETER

1.-11. (canceled)

12. An automatic planner comprising:
a memory, and
at least one processor configured to implement:
a target state inference unit configured to infer a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements;
a manipulation sequence inference unit configured to infer a manipulation for a transition to the partial target state based on a manipulation derivation rule;
a learning setting generation unit configured to generate a learning setting for the inferred manipulation based on a learning setting derivation rule, and outputting the generated learning setting to a learning agent configured to create information about detailed manipulations in the manipulation.

13. The automatic planner according to claim 12, wherein
the inference knowledge includes first inference knowledge defining a state before the manipulation and a target state after the manipulation while associating them with each other, and second inference knowledge defining a state transition between the states, and
the target state inference unit is configured to infer the target state by using the first inference knowledge and infers the partial target state by using the second inference knowledge.

14. The automatic planner according to claim 13, wherein the target state inference unit is configured to infer the partial target state by tracing back from the target state to the first state using the second inference knowledge.

15. The automatic planner according to claim 12, wherein the learning setting includes an input variable to the learning agent, an output variable of the learning agent, an objective function, and a type of learning.

16. The automatic planner according to claim 12, the at least one processor is configured to implement a state determination unit configured to determine whether or not the state of the system is a state that requires the manipulation.

17. An operation assistance method comprising:
inferring a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements;
inferring a manipulation for a transition to the partial target state based on a manipulation derivation rule;
generating a learning setting for the inferred manipulation based on a learning setting derivation rule, and outputting the generated learning setting to a learning agent configured to create information about detailed manipulations in the manipulation.

18. A non-transitory computer readable medium storing a program for causing a computer to perform processing including:
inferring a target state of a system and a partial target state thereof between a first state of the system and the target state thereof based on the first state, inference knowledge including a relation between states of the system, and quantitative knowledge including numerical knowledge in the system, the system being configured to be operated based on a manipulation procedure including an order of manipulation elements and a manipulated variable of each of the manipulation elements;
inferring a manipulation for a transition to the partial target state based on a manipulation derivation rule;
generating a learning setting for the inferred manipulation based on a learning setting derivation rule, and outputting the generated learning setting to a learning agent configured to create information about detailed manipulations in the manipulation.
